(19) United States
(12) Patent Application Publication
(10) Pub. No.: US 2008/0256283 A1
(43) Pub. Date: Oct. 16, 2008

(54) Multimedia expansion module and computer device using the same

(75) Inventors: Nai-Wei Chiu, Taipei (TW); Kuo-Chung Kao, Taipei (TW); Yu-Liang Liu, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/078,829

(22) Filed: Apr. 7, 2008

(30) Foreign Application Priority Data
Apr. 11, 2007 (TW) 96112778

(51) Int. Cl. G06F 13/40

(52) U.S. Cl. 710/306

(57) ABSTRACT

A multimedia expansion module suitable to be assembled in a computer device is provided. The multimedia expansion module includes a first group of pins, a second group of pins, a third group of pins, a first pin area and a second pin area. The first group of pins supports the transmission of universal serial bus (USB) signals. The second group of pins supports the transmission of serial disk drive interface signals. The third group of pins supports the transmission of peripheral component interconnect (PCI) express interface signal whose rate is at least 2.5 G bps. The third group of pins includes a first part of pins and a second part of pins. The first group of pins and the first part of pins are provided at the first pin area, and the second group of pins and the second part of pins are provided at the second pin area.

This application claims the benefit of Taiwan application Serial No. 96112778, filed Apr. 11, 2007, the subject matter of which is incorporated herein by reference.

### BACKGROUND OF THE INVENTION

1. Field of the Invention

The invention relates to a multimedia expansion module and, more particularly, to a multimedia expansion module which can simultaneously support the peripheral component interconnect express (PCI-E) interface, the universal serial bus (USB) and the serial disk drive interface and a computer device using the same.

2. Description of the Related Art

With the progress of the science and technology, the portable electronic device has been used more and more popularly. Generally speaking, the appearance of a portable electronic device is usually designed to be light, slim, short and small to make the portable electronic device brought readily. However, to reduce the volume of the portable electronic device to make the brought readily, the performance of the portable electronic device is not as good as a common electronic device.

For example, a notebook is usually provided with low level multimedia devices such as a built-in audio chip or a built-in VGA chip to make the notebook brought more readily. Therefore, when users want to use the notebook to execute high level software such as 3D graphic software or 3D game software, the hardware performance of the notebook is easy to be insufficient, and then the application program cannot be executed by the notebook or the application program cannot be executed fluently.

Therefore, when the hardware performance of the portable electronic device is not sufficient, users have to replace the portable electronic device with a high level portable electronic device. For the users using the portable electronic device, the problem that the hardware cannot be expanded effectively not only causes the inconvenience in the usage, but also increases the usage cost.

### BRIEF SUMMARY OF THE INVENTION

The invention relates to a multimedia expansion module and the computer device using the same, which can effectively improve the condition that conventional express card expansion slot can only support lower bandwidth and cannot support the hardware with a faster rate, and the cost is higher for the hardware of the portable computer cannot be effectively expanded.

According to the invention, a multimedia expansion module is provided. The multimedia expansion module is suitable to be assembled in the computer device. The multimedia expansion module includes a first group of pins, a second group of pins, a third group of pins, a first pin area and a second pin area. The first group of pins supports the transmission of the universal serial bus (USB) signal. The second group of pins supports the transmission of the serial disk drive interface signal. The third group of pins supports the transmission of peripheral component interconnect express (PCI-E) interface signal whose rate is at least 2.5 G bps. The third group of pins includes a first part of pins and a second part of pins. The first group of pins and the first part of pins are provided at the first pin area, and the second group of pins and the second part of pins are provided at the second pin area.

According to the invention, a computer device is provided. The computer device includes a north bridge chip, a multimedia peripheral chip and a multimedia expansion module. The multimedia peripheral chip is electrically connected to the north bridge chip. The multimedia expansion module includes a first group of pins, a second group of pins and a third group of pins. The first group of pins supports the transmission of the universal serial bus (USB) signal. The second group of pins supports the transmission of the serial disk drive interface signal. The third group of pins supports the transmission of peripheral component interconnect express (PCI-E) interface signal whose rate is at least 2.5 G bps. The first group of pins and the second group of pins are electrically connected to the multimedia peripheral chip, respectively, and the third group of pins is electrically connected to the multimedia peripheral chip or the north bridge chip.

According to the invention, a computer device including a north bridge chip, a multimedia peripheral chip, a multimedia expansion module and a switch unit is provided. The multimedia peripheral chip is electrically connected to the north bridge chip. The multimedia expansion module further includes a first group of pins electrically connected to the multimedia peripheral chip and supporting the transmission of the USB signal, a second group of pins electrically connected to the multimedia peripheral chip and supporting the transmission of the serial disk drive interface signal and a third group of pins supporting the transmission of the PCI express interface signal whose rate is at least 2.5 G bps. The switch unit is coupled to the north bridge chip, the multimedia peripheral chip and the third group of pins of the multimedia expansion module.

Therefore, the inventions has advantages of supporting the PCI express interface with a higher bandwidth, supporting the hardware with a faster rate effectively, expanding the computer device using the same effectively and making the cost lower.

These and other features, aspects, and advantages of the present invention will become better understood with regard to the following description, appended claims, and accompanying drawings.

### BRIEF DESCRIPTION OF THE DRAWINGS

FIG. 1 is a block diagram showing a computer device according to the first embodiment of the invention.

FIG. 2 is a block diagram showing the external expansion device according to the embodiment of the invention.

FIG. 3 is a schematic diagram showing the multimedia expansion card and the multimedia expansion module.

FIG. 4 is another schematic diagram showing the multimedia expansion module.

FIG. 5 shows the definitions of parts of the pins of the multimedia expansion module.

FIG. 6 shows the definitions of the other parts of pins of the multimedia expansion module 14.

FIG. 7 shows the definitions of the pins of the multimedia expansion modules of the second embodiment of the invention.

FIG. 8A and FIG. 8B show the definitions of the pins of the multimedia expansion modules of the third embodiment of the invention.

FIG. 9A and FIG. 9B show the definitions of the pins of the multimedia expansion modules of the fourth embodiment of the invention.

FIG. 10 is a block diagram showing the computer device according to the fifth embodiment of the invention.

FIG. 11 is a block diagram showing the computer device according to the sixth embodiment of the invention.

### DETAILED DESCRIPTION OF THE EMBODIMENTS

The embodiment of invention provides a multimedia expansion module which is suitable to be assembled in the portable computer device and can simultaneously support the transmission of the universal serial bus (USB) signal, the serial disk drive interface signal and the peripheral component interconnect express (PCI-E) interface signal to improve the expansion ability of the hardware of the computer device.

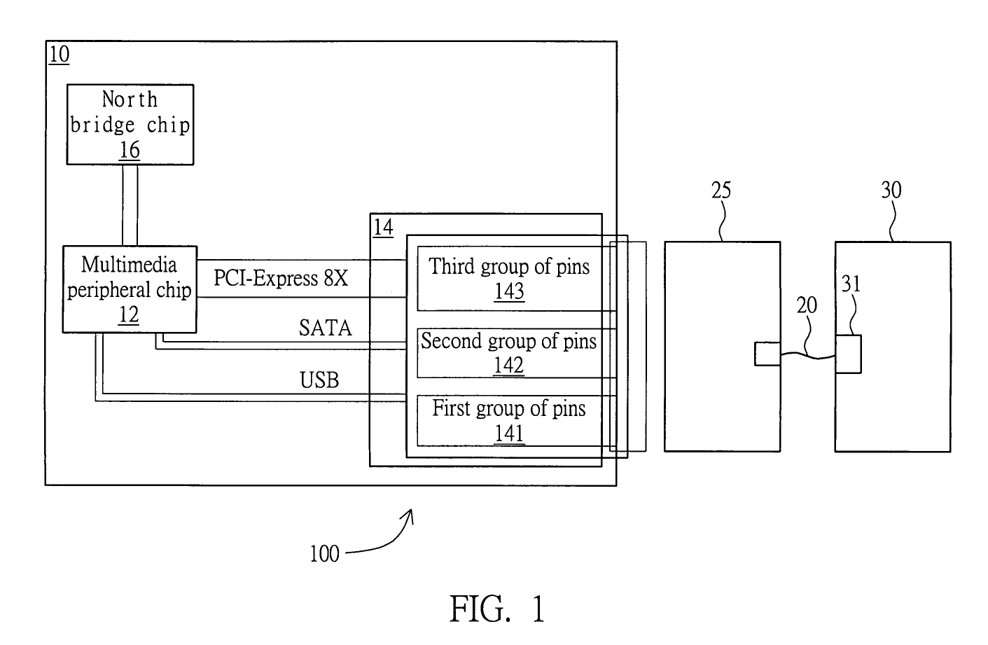

Please refer to FIG. 1, which is a block diagram showing the computer device of the first embodiment of the invention. The computer device 100 includes a motherboard 10, a multimedia peripheral chip 12, a multimedia expansion module 14 and a north bridge chip 16. The multimedia expansion module 14 includes a first group of pins 141, a second group of pins 142 and a third group of pins 143. In the embodiment, the computer device 100 is a portable computer device which may be a notebook, a tablet personal computer (tablet-PC) or an ultra mobile personal computer (UMPC). In other embodiments, the computer device 100 also can be a server, a bare system or a desktop.

The multimedia peripheral chip 12, the multimedia expansion module 14 and the north bridge chip 16 are all provided on the motherboard 10. In addition, the north bridge chip 16 is electrically connected to the multimedia peripheral chip 12, and the multimedia peripheral chip 12 further is electrically connected to the multimedia expansion module 14. In the embodiment, the multimedia peripheral chip 12 is a south bridge chip. In other embodiment, the multimedia peripheral chip 12 may be other equivalent chip. The first group of pins 141, the second group of pins 142 and the third group of pins 143 are all electrically connected to the multimedia peripheral chip 12.

The north bridge chip 16 can be electrically connected to the central processing unit (CPU), the graphic card (chip) or memory module. The multimedia peripheral chip 12 can be electrically connected to other peripheral devices such as the optical disc drive, the disk drive or the network chip.

In the embodiment, the multimedia expansion module 14 is an expansion card slot which can receive an expansion card such as an express card. In other embodiment, the multimedia expansion module 14 may be expansion connector or expansion connection port which can connect the corresponding expansion connector. In the embodiment, the first group of pins 141 can support the transmission of the USB signal, the second group of pins 142 can support the serial disk drive interface signal, and the third group of pins 143 can support the transmission of the PCI express signal. Furthermore, the multimedia expansion module 14 provided in the embodiment can support the transmission of the USB signal, the serial disk drive interface signal and the PCI express signal, simultaneously.

In the embodiment, the serial disk drive interface is serial advanced technology attachment (SATA) interface. In other embodiment, the serial disk drive interface may be serial attached small computer system interface (SCSI). In the embodiment, the transmission rate of the PCI express signal is at least more than 2.5 G bps (1×), and it is preferred to be 8× (which is equal to 2.5×8 G bps). In other embodiment, the transmission rate of the PCI express signal may be 16× (which is equal to 2.5×16 G bps).

Certainly, to enable the multimedia expansion module 14 to support the three kinds of the signal transmission, the multimedia peripheral chip 12 is electrically connected to the multimedia expansion module 14 via the USB, SATA and PCI express bus, respectively.

Thus, the computer device 100 provided in the embodiment can be electrically connected to an external expansion device 30 via the multimedia expansion module 14, wherein the external expansion device 30 can be electrically connected to the computer device 100 via the multimedia transmission line 20 and the multimedia expansion card 25. One end of the multimedia transmission line 20 is suitable to be inserted on the connector 31 of the external expansion device 30, and the other end of the multimedia transmission line 20 is inserted on the multimedia expansion card 25 which is suitable to be inserted in the multimedia expansion module 14.

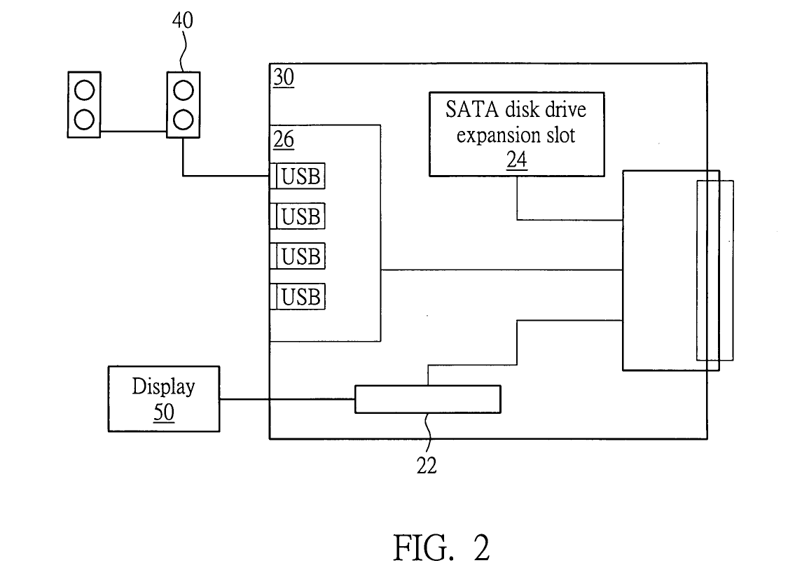

In the embodiment, the external expansion device 30 is an external multimedia expansion device, and the function block diagram thereof is shown in FIG. 2. The external expansion device 30 includes at least a PCI express expansion card slot 22, a SATA disk drive expansion slot 24 and a plurality of USB expansion ports 26, wherein the PCI express expansion slot 22 is suitable to receive a high level graphic card or a physics accelerator, and the high level graphic card can be electrically connected to a display 50, the SATA disk drive expansion slot 24 is suitable to be electrically connected to the SATA disk drive, and the USB expansion port 26 can be electrically connected to the USB interface peripheral device such as a loudspeaker 40.

Since the multimedia expansion module 14 of the embodiment can support the transmission rate of the PCI express signal which is 8× (or 16×), the computer device 100 of the embodiment can be electrically connected to the high level graphic card by the coupled external expansion device 30 to improve the hardware performance of the computer device 100. In addition, the computer device 100 of the embodiment can be electrically connected to an external SATA disk drive via the coupled external expansion device 30 to expand the storage capacity of the computer device 100.

The definitions of the first group of pins 141, the second group of pins 142 and the third group of pins 143 of the multimedia expansion module 14 and the implement situation are described hereinbelow.

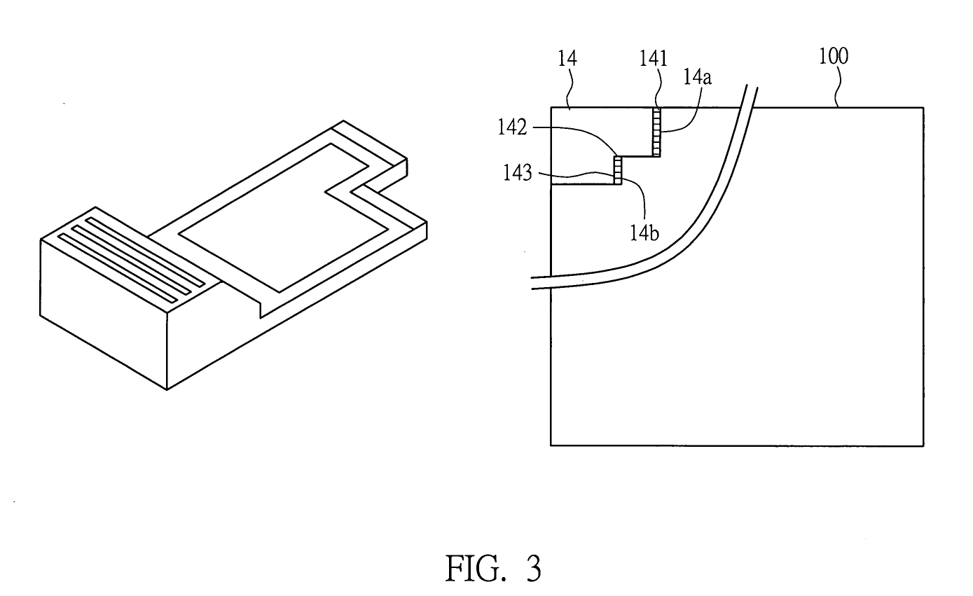

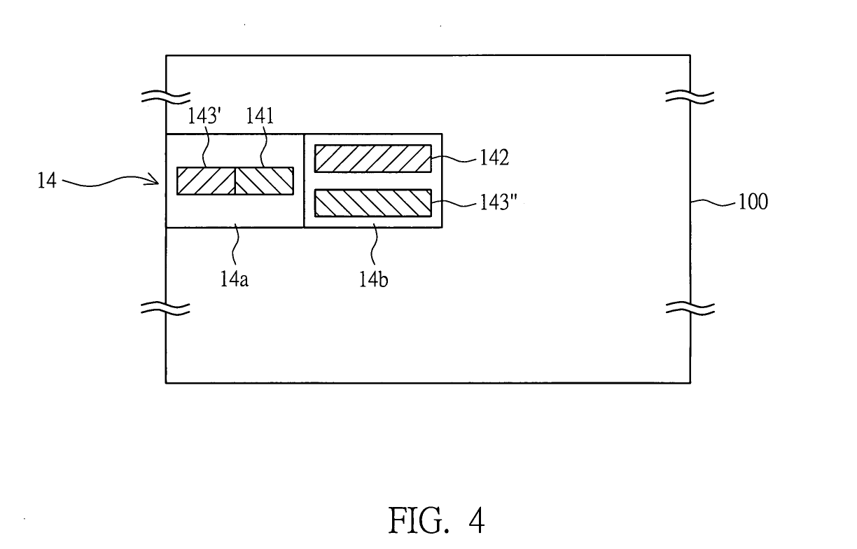

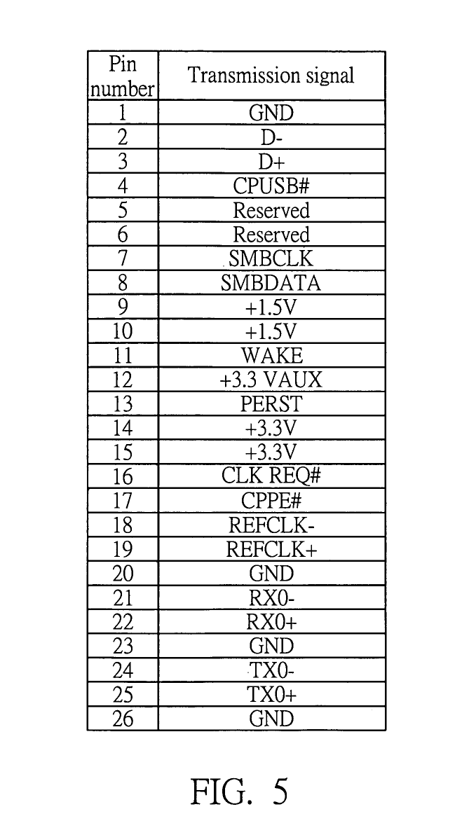

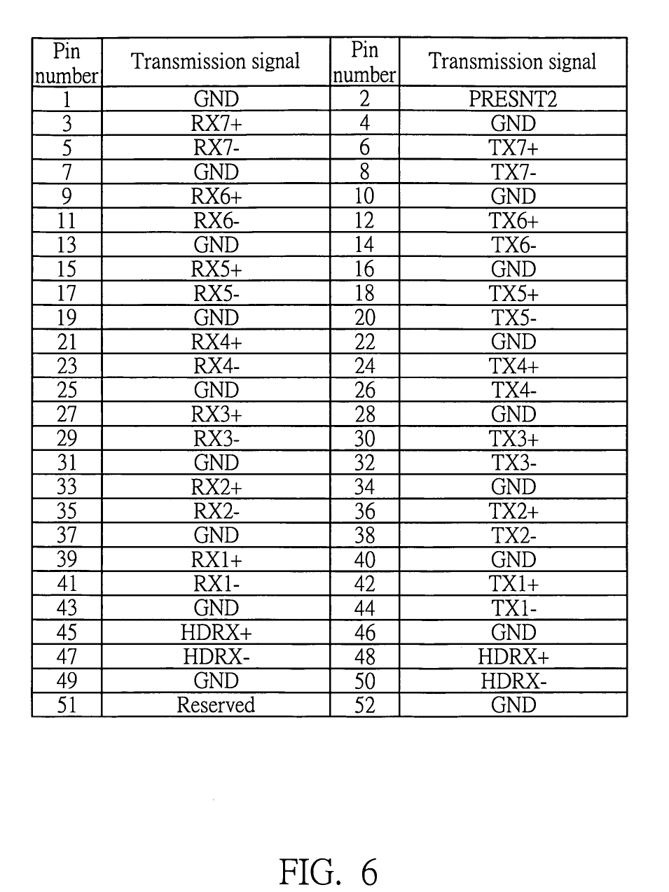

As for the explanations of the pins of the multimedia expansion module 14 in the embodiment, please refer to FIG. 3, FIG. 4, FIG. 5 and FIG. 6 simultaneously. FIG. 3 is a schematic diagram showing the multimedia expansion card 25 and the multimedia expansion module 14, FIG. 4 is another schematic diagram showing the multimedia expansion module 14, FIG. 5 shows the definitions of parts of the pins of the multimedia expansion module 14, and FIG. 6 shows the definitions of the other parts of pins of the multimedia expansion module 14.

In FIG. 3, the multimedia expansion module 14 has a first pin area 14a and a second pin area 14b. The first group of pins 141 and parts of the third group of pins 143 are provided at the first pin area 14a, and the second group of pins 142 and parts of the third group of pins 143 are provided at the second pin area 14b. The first pin area 14a and the second pin area 14b are provided at different planes. For example, the depth of the plane where the first pin area 14a is provided is deeper than that of the plane where the second pin area 14b is provided.

To make the description easy, the third group of pins 143 of the embodiment can include a first part of pins 143′ and a second part of pins 143″, as shown in FIG. 4. The first part of pins 143′ of the third group of pins 143 and the first group of pins 141 are both provided at the first pin area 14a, and the first part of pins 143′ and the first group of pins 141 are provided at the same layer. The second part of pins 143″ of the third group of pins 143 and the second group of pins 142 are both provided at the second pin area 14b, and the second part of pins 143″ and the second group of pins 142 are provided to form a double layer.

That is, in the embodiment, the first group of pins 141 and the first part of pins 143′ of the third group of pins 143 can be provided at one end of the multimedia expansion module 14, the second group of pins 142 and the second part of pins 143″ of the third group of pins 143 can be provided at the other end of the multimedia expansion module 14, and the second group of pins 142 and the second part of pins 143″ of the third group of pins 143 are provided abreast. For example, the second group of pins 142 is provided at the upper row, the second part of pins 143″ of the third group of pins 143 is provided at the lower row.

In other embodiments, the first group of pins 141, the second group of pins 142 and the third group of pins 143 may be provided abreast or on the same plane. In the embodiment, the pin disposition and the pin definition of multimedia expansion card 25 also need to correspond to the pin disposition and the pin definition of the multimedia expansion module 14.

The pin definitions shown in FIG. 5 include the definitions of the first group of pins 141 and the first part of pins 143′ of the third group of pins 143. The number of the defined pins is twenty six. The definitions of the pins can be like the pin definitions of a common PCI express slot to make the first group of pins 141 and the first part of pins 143′ of the third group of pins 143 can support the transmission of the USB signal and PCI express 1× (2.5 G bps) signal. That is, the first part of pins 143′ can support the transmission of the PCI express 1× signal, wherein the pins 1 to 4 can be used to transmit the USB signal, and the pins 13 to 26 can be used to transmit the PCI express signal.

In the FIG. 6, the pin definitions include the definitions of the second group of pins 142 and the second part of pins 143″ of the third group of pins 143, wherein the number of the defined pins is fifty two. In the pin definitions of the FIG. 6, the second group of pins 142 and the second part of pins 143″ of the third group of pins 143 can provide the transmission of SATA signals and the PCI express 1× to 7× signals, wherein the pins 45 to 50 can be used to transmit the SATA signal, the pins 3, 5 to 44 can be used to transmit the PCI express signal, the pins 2 and 4 can be used as hot-plug pins to transmit the hot-plug signal PRSNT2. Therefore, the computer device 100 can determine whether hot-plug hardware is connected thereto according to the level of the hot-plug signal PRSNT2.

In the embodiment, the first part of pins 143′ of the third group of pins 143 in FIG. 5 can provide the transmission of the PCI express 1× signal, and the second part of pins 143″ of the third group of pins 143 in FIG. 6 can provide the transmission of the PCI express 1× to 7× signal. Therefore, the multimedia expansion module 14 provided by the embodiment provides the transmission of the PCI express 8× signal.

In the embodiment, the disk drive sequential transmission interface is, for example, SATA interface. However, the multimedia expansion module provided by the embodiment not only can support the SATA interface, it also can support other disk drive sequential transmission interface such as the serial attached SCIS (SAS).

In addition, in the embodiment, the external expansion device 30 electrically connected to the multimedia expansion module 14 can cooperate with an external power supply (please refer to FIG. 1 simultaneously), and therefore the power supply pin in the pin definition in FIG. 6 can be omitted.

Furthermore, since the definition of the first group of pins 141 of the multimedia expansion module 14 of the embodiment is the same with the definition of the pins of a common PCI express slot, the multimedia expansion module 14 in the embodiment also is compatible with the express card on the market. For example, it is compatible with the express card 34 and the express card 54.

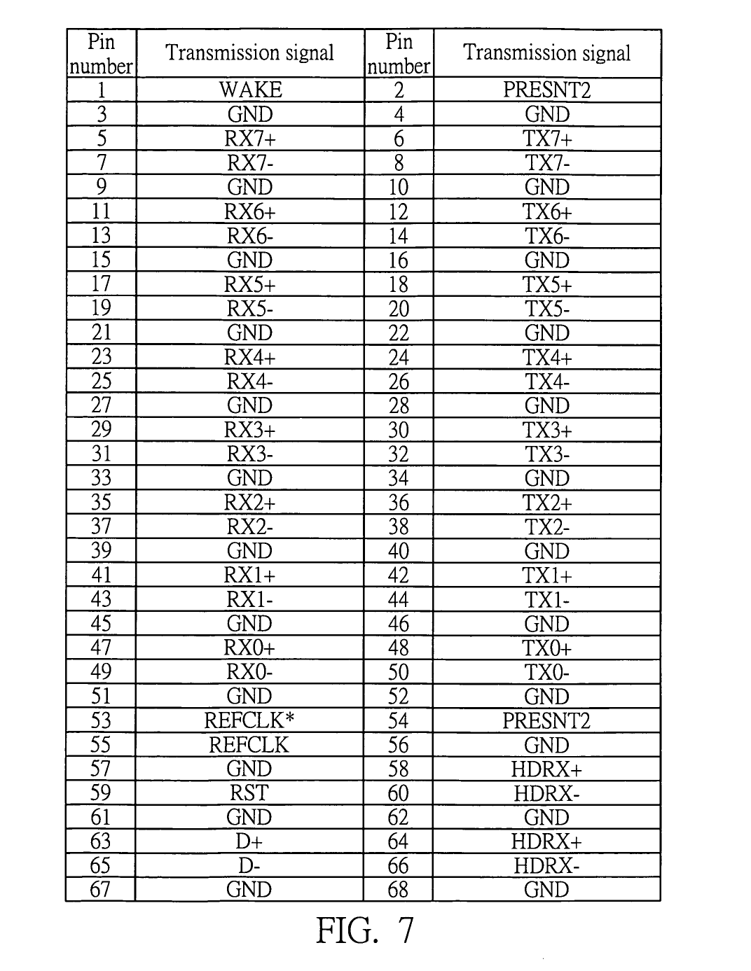

FIG. 7 shows the pin definitions of the multimedia expansion module 14 according to the second embodiment of the invention, and please refer to FIG. 1 and FIG. 3 simultaneously. In the embodiment, the number of the pins of the first group of pins 141, the second group of pins 142 and the third group of pins 143 is sixty eight. In FIG. 7, the pins 5 to 55, 57, 59 and 61 can be used to transmit the PCI express signal and can provide the transmission of the PCI express 8× signal. The pins 58, 60, 62, 64, 66 and 68 can be used to transmit the SATA signal. The pins 63, 65, 67 can be used to transmit the USB signal. The pins 2, 4, 54 and 56 can be used as the hot-plug pins.

The second embodiment is similar to the first embodiment. In the second embodiment, the pin definition of the power supply pin is omitted in FIG. 7 to simplify the number of pins. In addition, in this embodiment, the first group of pins 141 and the first part of pins 143′ of the third group of pins 143 can be provided at one end of the multimedia expansion module 14, and the second group of pins 142 and the second part of pins 143″ of the third group of pins 143 are provided at the other end of the multimedia expansion module 14 and can be provided abreast. Certainly, in the embodiment, the pin number and the disposition position of the first group of pins 141, the second group of pins 142 and the third group of pins 143 also can be charged similarly.

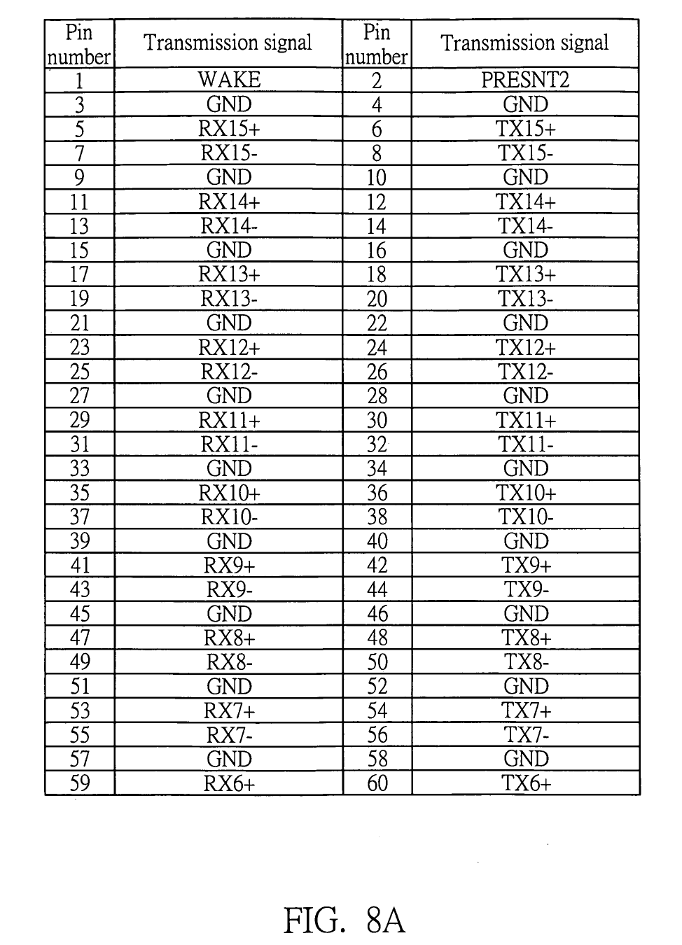

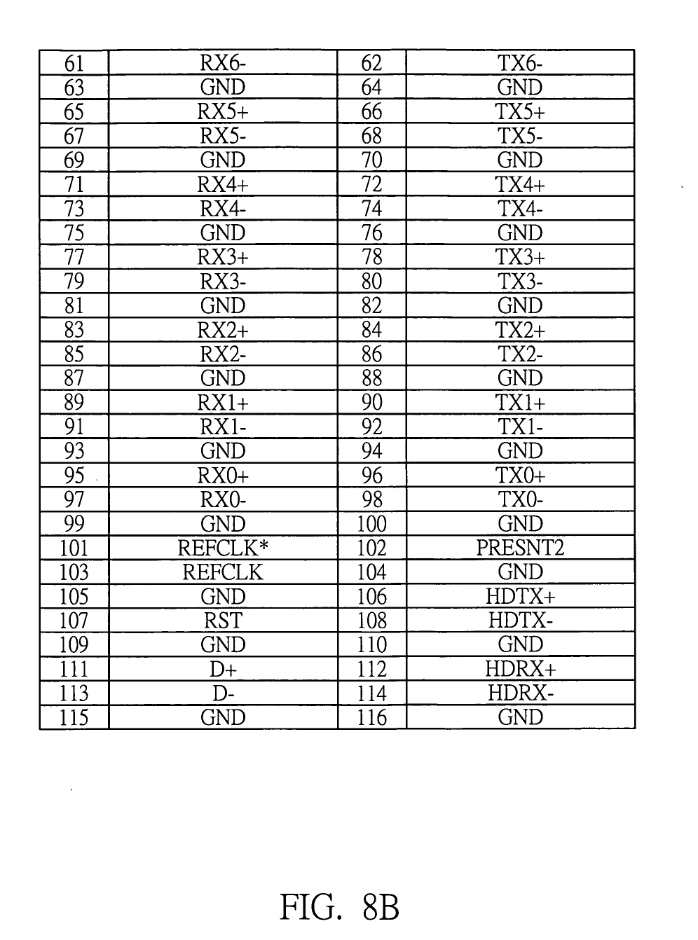

FIG. 8A and FIG. 8B show the pin definitions of the multimedia expansion module 14 according to the third embodiment of the invention, and please refer to FIG. 1 simultaneously. In the embodiment, the pin number of the first group of pins 141, the second group of pins 142 and the third group of pins 143 of the multimedia expansion module is one hundred and sixteen. In FIG. 8A and FIG. 8B, the pins 5 to 102, 103, 105, 107 and 109 can be used to transmit the PCI express signal and provide the transmission of the PCI express 16× signals. The pins 106, 108, 110, 112, 114 and 116 can be used to transmit the SATA signal. The pins 111, 113, 115 can be used to transmit the USB signal. The pins 2, 4, 102 and 104 can be used as the hot-plug pins.

The third embodiment is similar to the first embodiment. The definition of the power supply pin is omitted in FIG. 8A and FIG. 8B to simplify the number of the pins. Similarly, in the embodiment, the pin number and the deposition position of first group of pins 141, the second group of pins 142 and the third group of pins 143 can be similar to that of the second embodiment.

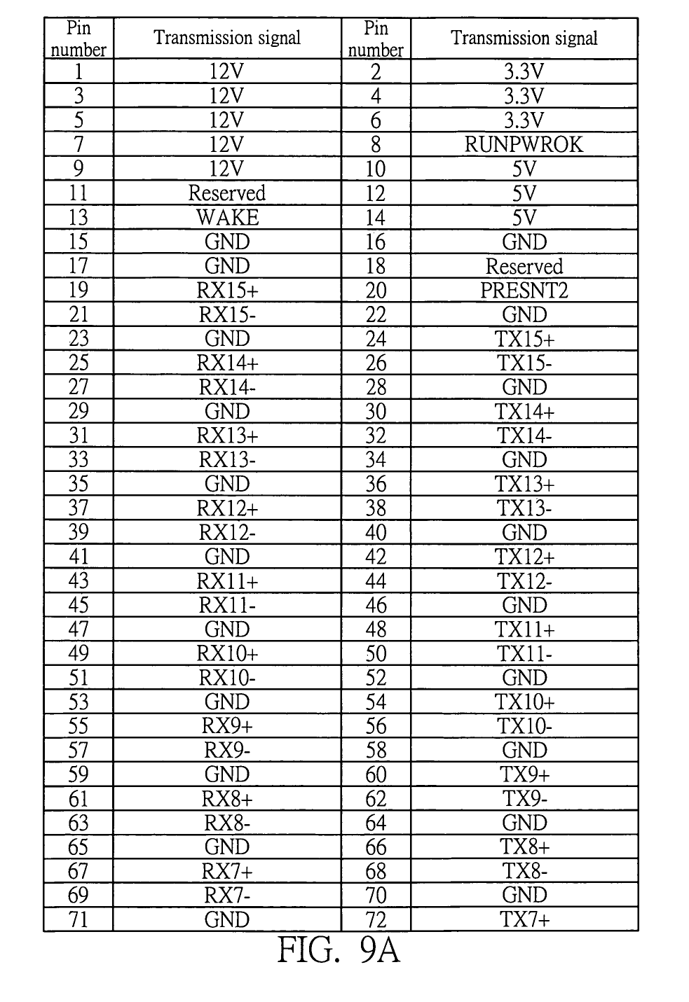

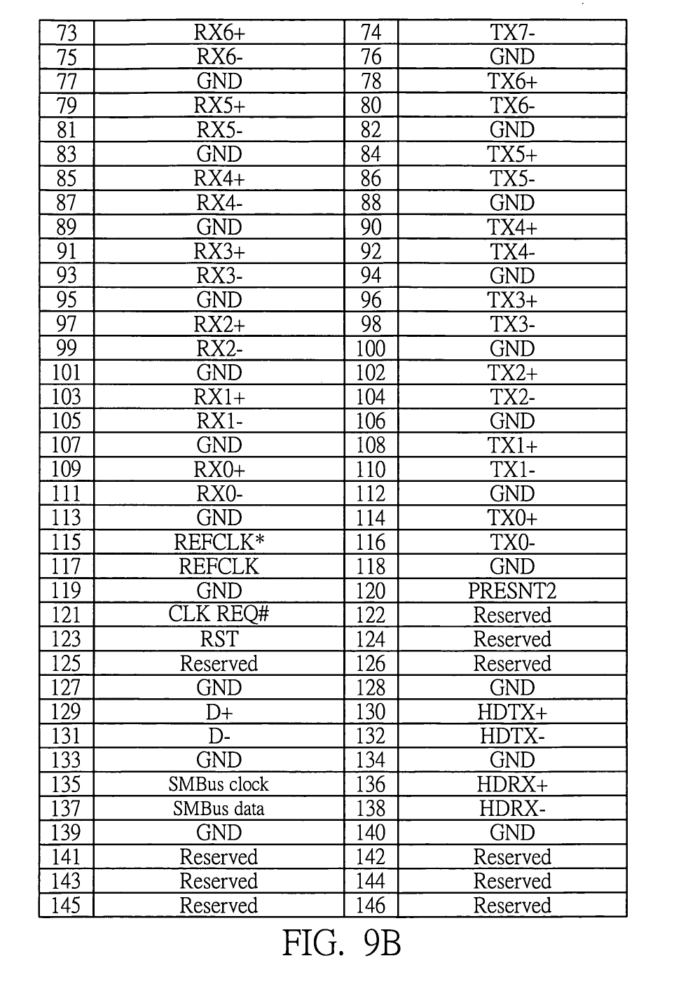

FIG. 9A and FIG. 9B shows the pin definition of the multimedia expansion module 14 of the fourth embodiment of the invention, and please refer to FIG. 1 simultaneously. In the embodiment, the number of the pins of the first group of pins 141, the second group of pins 142 and the third group of pins 143 of the multimedia expansion module 14 is one hundred and forty six. In the FIG. 9A and FIG. 9B, the pins 19, 21, 23 to 119, 121, 123 can be used to transmit the PCI express signal and can provide the transmission of the PCI express 16× signal. The pins 130, 132, 134, 136, 138 and 140 can be used to transmit the SATA signal. The pins 129, 131 and 133 can be used to transmit the USB signal. The pins 135, 137 and 139 can be used to transmit the system management bus (SMBUS) signal, wherein the SMBUS signal also can be called as the Inter-Integrated Circuit (I2C) signal. The pins 20, 22, 120 and 122 can be used as the hot-plug pins.

In the embodiment, power supply pins such as the pins 1 to 17 are provided. In addition, in the embodiment, the definitions of a plurality of pins such as the pins 11, 18, 122, 124 to 126, 141 to 146 are reserved. The reserved pins can increase the expansibility of the multimedia expansion module 14. If a new changed interface standard appears, the multimedia expansion module 14 can be compatible with the pin definition of the new standard without changing the entity of connector. Similarly, in the embodiment, the corresponding pin number and the disposition position of the first group of pins 141, the second group of pins 142 and the third group of pins 143 can be similar to that of the second embodiment.

To sum up, the multimedia expansion module provided by each embodiment of the invention can effectively improve the condition that the conventional express card expansion slot only can support lower bandwidth and cannot support the hardware with a faster rate. For example, the performance of the external connected high level graphic card can be effectively brought into play via the multimedia expansion module provided by the embodiment of the invention. In addition, various external connected devices such as the electronic device with the USB interface, SATA disk drive, high level graphic card with the PCI express interface or physics accelerator with the PCI express interface can be connected simultaneously via the multimedia expansion module provided by the embodiment of the invention. That is, the multimedia expansion module provided by the embodiment of the invention can transmit the PCI express signal, USB signal and SATA signal simultaneously.

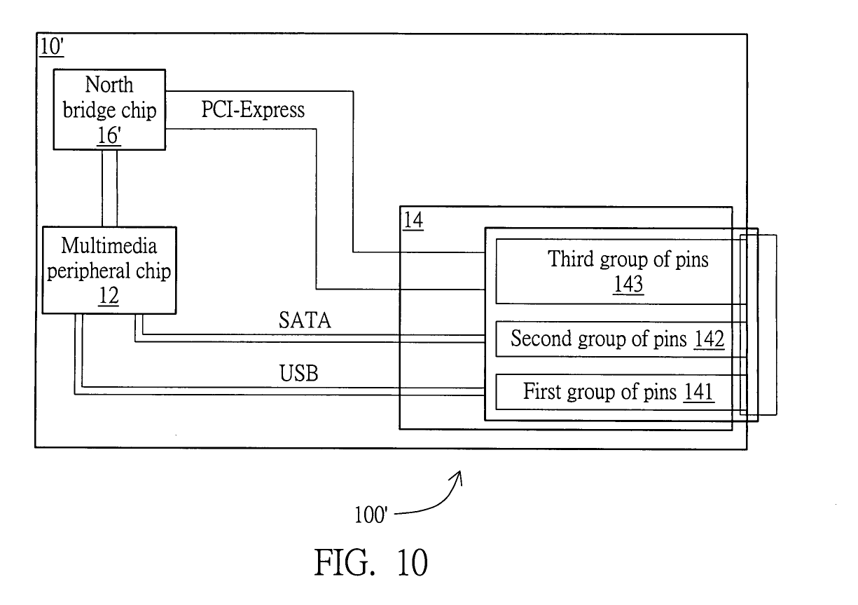

FIG. 10 is a block diagram showing the computer device 100′ of the fifth embodiment of the invention. The computer device 100′ of the embodiment is different from the computer device 100 of the first embodiment. The north bridge chip 16′ of the computer device 100′ of the embodiment is electrically connected to the third group of pins 143 of the multimedia expansion module 14, and the first group of pins 141 and the second group of pins 142 are electrically connected to the multimedia peripheral chip 12, respectively, so that the PCI express signal with a high rate such as the PCI express 16× signal can be transmitted between the north bridge chip 16′ and the multimedia expansion module 14. In addition, the USB signal and the SATA signal still can be transmitted between the multimedia expansion module 14 and the multimedia peripheral chip 12.

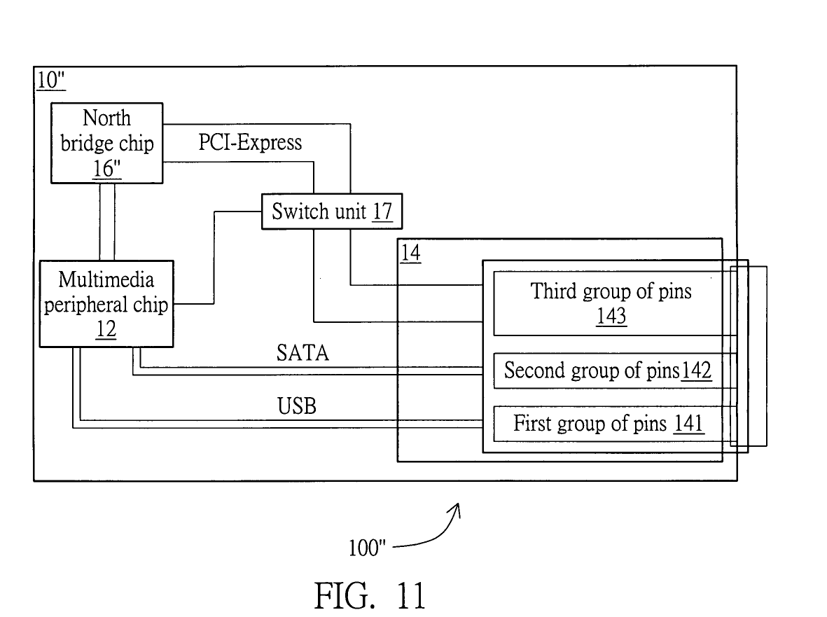

FIG. 11 shows the block diagram showing the computer device 100″ according to the sixth embodiment of the invention. The computer device 100″ of the embodiment is different from the computer device 100 of the first embodiment. The computer device 100″ of the embodiment further includes a switch unit 17 coupled to the north bridge chip 16″, the multimedia peripheral chip 12, the third group of pins 143 of the multimedia expansion module 14. In addition, the first group of pins 141 and the second group of pins 142 are electrically connected to the multimedia peripheral chip 12, respectively.

In the embodiment, a bus which can transmit the PCI express 1× signal is provided between the multimedia peripheral chip 12 and the switch unit 17. A bus which can transmit the PCI express signal whose transmission rate is at least 2× is provided between the north bridge chip 16″ and the switch unit 17. For example, a bus which can transmit the PCI express signal whose transmission rate is at least 8× can be provided.

In addition, the switch unit 17 can switch between different PCI express signal buses with different transmission rates according to the different kinds of the expansion cards. For example, when a common express card is inserted, the switch unit 17 can switch the PCI express signal bus to the multimedia peripheral chip 12 according to the pin signal generated when the express card is inserted. That is, the switch unit 17 is electrically connected to the multimedia peripheral chip 12 via the PCI express signal bus with 1× transmission rate. When an expansion card (an expansion card which can provide the signal transmission of the PCI express 8×) collocating with the embodiment is inserted, the switch unit 17 also can switch the PCI express signal bus to the north bridge chip 16″ according to the pin signal generated when the expansion card is inserted. That is, the switch unit 17 is electrically connected to the north bridge chip 16″ via the PCI express signal bus with an 8× transmission rate.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multimedia expansion module which is suitable to be assembled in a computer device, the multimedia expansion module comprising:
a first group of pins supporting the transmission of a universal serial bus (USB) signal;
a second group of pins supporting the transmission of a serial disk drive interface signal;
a third group of pins supporting the transmission of a peripheral component interconnect express (PCI-E) interface signal whose rate is at least 2.5 G bps, wherein the third group of pins comprises a first part of pins and a second part of pins;
a first pin area; and
a second pin area,
wherein the first group of pins and the first part of pins are provided at the first pin area, and the second group of pins and the second part of pins are provided at the second pin area.

2. The multimedia expansion module according to claim 1, wherein the second pin area and the first pin area are provided at different planes.

3. The multimedia expansion module according to claim 1, wherein the first part of pins can support the transmission of a PCI express signal whose rate is 2.5 G bps.

4. The multimedia expansion module according to claim 1, wherein the computer device further comprises a multimedia peripheral chip, and the first group of pins, the second group of pins and the third group of pins are electrically connected to the multimedia peripheral chip, respectively.

5. The multimedia expansion module according to claim 1, wherein the computer device further comprises a multimedia peripheral chip and a north bridge chip, the first group of pins and the second group of pins are electrically connected to the multimedia peripheral chip, respectively, and the third group of pins is electrically connected to the north bridge chip.

6. The multimedia expansion module according to claim 1, wherein the first group of pins, the second group of pins and the third group of pins can support the transmission of the USB signal, the serial disk drive interface signal and the PCI express signal simultaneously.

7. A computer device comprising:
a north bridge chip;
a multimedia peripheral chip electrically connected to the north bridge chip; and
a multimedia expansion module comprising:
a first group of pins supporting the transmission of a universal serial bus (USB) signal;
a second group of pins supporting the transmission of a serial disk drive interface signal; and
a third group of pins supporting the transmission of a peripheral component interconnect express (PCI-E) interface signal whose rate is at least 2.5 G bps,
wherein the first group of pins and the second group of pins are electrically connected to the multimedia peripheral chip, respectively, and the third group of pins is electrically connected to the multimedia peripheral chip or the north bridge chip.

8. The computer device according to claim 7, wherein the third group of pins further comprises a first part of pins and a second part of pins, the multimedia expansion module further comprises a first pin area and a second pin area, the first group of pins and the first part of pins are provided at the first pin area, and the second group of pins and the second part of pins are provided at the second pin area.

9. The computer device according to claim 8, wherein the second pin area and the first pin area are provided at different planes.

10. The computer device according to claim 8, wherein the first part of pins can support the transmission of the PCI express interface signal whose rate is 2.5 G bps.

11. The computer device according to claim 7, wherein the first group of pins, the second group of pins and the third group of pins can support the transmission of the USB signal, the serial disk drive interface signal and the PCI express interface signal simultaneously.

12. A computer device comprising:
a north bridge chip;
a multimedia peripheral chip electrically connected to the north bridge chip;
a multimedia expansion module comprising:
a first group of pins electrically connected to the multimedia peripheral chip and supporting the transmission of a universal serial bus (USB) signal;
a second group of pins electrically connected to the multimedia peripheral chip and supporting the transmission of a serial disk drive interface signal; and
a third group of pins supporting the transmission of a peripheral component interface express (PCI-E) signal whose rate is at least 2.5 G bps; and
a switch unit coupled to the north bridge chip, the multimedia peripheral chip and the third group of pins of the multimedia expansion module, respectively.

13. The computer device according to claim 12, wherein the third group of pins further comprises a first part of pins and a second part of pins, the multimedia expansion module further comprises a first pin area and a second pin area, the first group of pins and the first part of pins are provided at the first pin area, and the second group of pins and the second part of pins are provided at the second pin area.

14. The computer device according to claim 13, wherein the second pin area and the first pin area are provided at different planes.

15. The computer device according to claim 13, wherein the first part of pins can support the transmission of the PCI express interface signal whose rate is 2.5 G bps.

16. The computer device according to claim 12, wherein the first group of pins, the second group of pins and the third group of pins can support the transmission of the USB signal, the serial disk drive interface signal and the PCI express interface signal simultaneously.
